(19) United States
(12) Patent Application Publication
(10) Pub. No.: US 2008/0298949 A1
(43) Pub. Date: Dec. 4, 2008

(54) Palletizing Unit and Method for Installing a Palletizing Unit

(75) Inventor: Erik van Heijningen, Oosterhout (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CSI INDUSTRIES B.V., RAA,SDPMLSVEER (NL)

(21) Appl. No.: 11/884,599

(22) PCT Filed: Feb. 16, 2006
(86) PCT No.: PCT/NL2006/000079

§ 371 Date: Apr. 17, 2008

(30) Foreign Application Priority Data
Feb. 21, 2005 (NL) 1028359

(51) Int. Cl. B65G 61/00

(52) U.S. Cl. 414/791.6; 29/428

(57) ABSTRACT

The invention relates to a palletizing unit (1) for palletizing or depalletizing pallets (12). The unit comprises at least one stationing location (11) for a pallet (12) which is to be loaded or has been loaded. The unit also comprises a conveyor (4) for introducing or removing objects which are to be loaded onto the pallet or have been loaded from the pallet into or from the palletizing unit. The palletizing unit (1) has a robot (2) for picking up the objects from the conveyor (4) and placing the objects onto the pallet (12) on the stationing location (11), or vice versa. The unit also comprises a base (14) which, after the unit (1) has been installed at an operating location, rests on a floor (15). The stationing location (11), the conveyor (4) and the robot (2) are placed onto the base (14) and fixedly connected to one another.

### CROSS-REFERENCE TO RELATED APPLICATIONS

This application is a U.S. National Phase of PCT/NL2006/000079, filed Feb. 16, 2006, which claims priority to Netherlands Patent Application No. 1028359, filed Feb. 21, 2005. The contents of both of the aforementioned applications are herein incorporated by reference in their entirety.

### BACKGROUND OF THE INVENTION

The invention relates to a palletizing unit for palletizing and depalletizing objects, comprising at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor.

A palletizing unit of this type is known. In the known palletizing unit, a pallet which is to be loaded is placed onto the end of a roller track within the reach of a robot placed on a floor. The goods to be loaded onto the pallet are supplied with the aid of a conveyor, with the end part of the conveyor being located within reach of the robot. The robot picks up the objects from the conveyor and stacks them on the pallet.

### BRIEF SUMMARY OF THE INVENTION

It is an object of the invention to provide an improved palletizing unit.

According to the invention, this object is achieved by a palletizing unit for palletizing and depalletizing objects, comprising at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor. The unit also comprises a base which, after the unit has been installed at an operating location, rests on a floor, on which base the stationing location, the conveyor and the robot are placed and fixedly connected to one another.

In the palletizing unit according to the invention, the components, namely the robot, the stationing location and the conveyor, are arranged on a common base. One advantage of this is that the palletizing unit can be assembled at an assembly location on the supplier's premises, in which case the robot, the stationing location and the conveyor can be accurately positioned with respect to one another and fixed to the base. The position of the stationing location and the conveyor can be input into the control system of the associated robot at the supplier's assembly location. Since the position of the robot, the stationing location and the conveyor with respect to one another no longer changes after assembly, it becomes possible for the palletizing unit, after it has been transported to the customer's operating location, to be fitted all at once at that location, after which all that is necessary is the physical and electronic coupling to the devices connecting to the palletizing unit, such as conveyor tracks and the like, for discharging and optionally supplying pallets and supplying goods that are to be palletized in order for the unit to be made ready for use.

The stationing location can be designed in various ways, for example as a roller track, a chain track, a trestle or a location on the floor on which the pallet is placed.

The invention also relates to a method for installing a palletizing unit, which palletizing unit comprises at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor, wherein at an assembly location the robot, the stationing location and the conveyor are arranged fixedly on a base in order to form a palletizing unit, the unit formed is conveyed to an operating location, where the base of the unit is placed and fixed on a floor surface.

The method according to the invention avoids time-consuming operations, such as the accurate determination of the position of the robot and the stationing location and the conveyor, at the operating location, as well as the adjustment of the robot. After transport, the palletizing unit can be placed where desired by the user and put into use almost immediately after connection to the electrical power supply and coupling to the connecting devices.

Preferred embodiments of the invention are defined in the dependent claims.

The invention will be explained in more detail in the description below with reference to the drawing.

### BRIEF DESCRIPTION OF THE DRAWINGS

FIG. 1 shows a plan view of an embodiment of a palletizing unit according to the invention,

FIG. 2 shows a front view of the palletizing unit from FIG. 1,

FIG. 2a diagrammatically depicts a detail of a palletizing cell according to the invention,

FIG. 3 shows a side view of the palletizing unit from FIG. 1,

FIG. 4 shows a plan view of another embodiment of a palletizing unit according to the invention,

FIG. 5 shows a front view of the palletizing unit from FIG. 4,

FIG. 6 shows a plan view of yet another embodiment of a palletizing unit according to the invention,

FIG. 7 shows a front view of the palletizing unit from FIG. 6,

FIG. 8 shows a cross section through a container in which three palletizing units are accommodated for transport, and

FIG. 9 shows a plan view of a further preferred embodiment of a palletizing unit according to the invention.

### DETAILED DESCRIPTION OF THE INVENTION

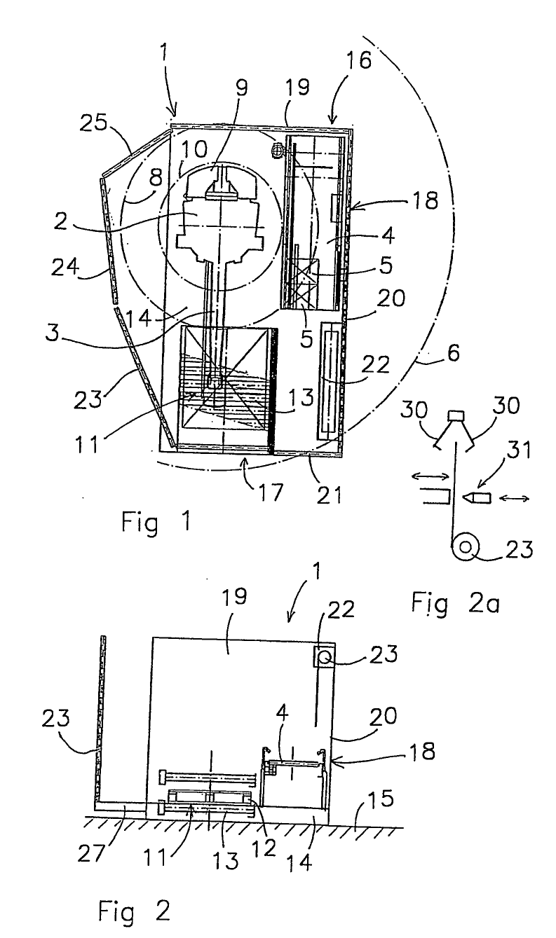

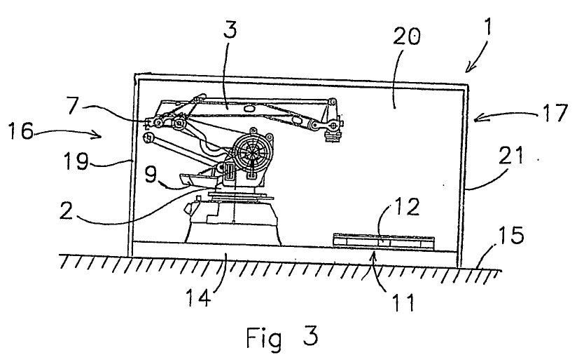

FIGS. 1 to 3 show a palletizing unit 1 in an installed state. The palletizing unit 1, which is also referred to as a palletizing cell, comprises a robot 2 with a robot arm 3. The reach of the head of the robot arm 3 is illustrated by the arc 6. The reach of a point 7 of the robot arm 3 which is located furthest to the rear when the robot arm 3 is folded (cf. FIG. 3) is illustrated by a circle 8 in FIG. 1. The turning circle of the point 9 of the robot is indicated by reference numeral 10.

The palletizing cell 1 also comprises an introduction conveyor 4, on which objects 5, for example boxes, are conveyed into the palletizing cell 1. If the palletizing cell is used for depalletizing objects, the conveyor 4 can be used as a removal conveyor.

The palletizing cell 1 also comprises a stationing location 11 for a pallet 12. In this embodiment, the stationing location 11 for the pallet 12 is formed by a conveyor in the form of a roller track 13, by which the empty pallet 12 can be conveyed in the palletizing cell 1 and the pallet, in the loaded state (not shown), can be conveyed out of the palletizing cell 1, or vice versa.

The palletizing cell 1 also comprises a base 14 which is of substantially rectangular design. The base 14 forms a supporting structure for the robot 2 which is placed and secured on it. The introduction conveyor 4 and the roller track 13 are also arranged on the base 14 and fixed with respect thereto. In this specific embodiment, the roller track 13 is arranged recessed in the base 14, but may also be located above it or be movable in the vertical direction.

The base 14 is preferably formed by a frame of welded-together steel bar profiled sections or flanged profiled sections. If appropriate, a covering plate can be arranged on the frame. At the location of use or operating location, the base 14 is placed on a floor surface 15. The width of the base is preferably approximately 225 cm. The length of the base is preferably 390 cm. In the folded state of the robot 2 (cf. FIG. 3), for example during transport of the palletizing cell 1, the peripheral dimension is determined by the dimension of the base 14.

On the base 14, it is preferable for vertical safety shields 19, 20 and 21 to have already been arranged on two short sides 16 and 17 and one long side 18. The safety shields 19, 20, 21 are, for example, provided with mesh and are used to shield the machine.

A reel holder 22 for receiving a reel 23 of material, from which inlay sheets are cut, is arranged on the shield 20 in line with the conveyor 4 which is positioned along the safety shield 20; these inlay sheets are then arranged on a layer of objects 5 on the pallet 12 by the robot 2 before the next layer of objects 5 is stacked on top. For this purpose, by way of example, a number of gripper members 30 (cf. FIG. 2a), by means of which the robot 2 is able to take hold of the sheet in the reel holder 22, are located in the robot head. As a result of the head then being moved away from the reel holder 22, the sheet is unrolled. When the sheet which has been unrolled is large enough, the sheet is cut off by cutting means 31, for example a cutting blade or a heatable wire, arranged on the reel holder 22. The robot 2 can then place the inlay sheet on a layer of objects 5.

It can be seen in FIGS. 1 and 2 that three safety shields 24, 25 and 26 are arranged at the other long side outside the periphery of the base 14. This more “generous” positioning of the shields 24-26 is necessary with the type of robot shown in order to give the robot 2 sufficient space to be able to rotate and pick up objects 5 from the introduction conveyor 4 and place them onto the pallet 12. With other types of robots, this may not be necessary. In the embodiment shown, the safety shields 24-26 are placed on a platform 27 arranged at the side of the base 14, as shown in FIG. 2. However, it is also possible for the shields 24-26 to be placed on the floor surface 15.

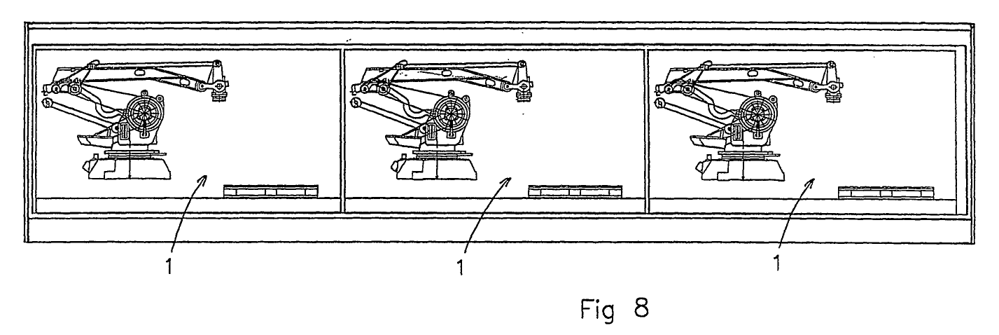

The palletizing unit 1 is assembled at an assembly location at the supplier's premises, with the robot 2, the roller conveyor 13, the introduction conveyor 4 being secured to the base 14. The safety shields 19-21 can also be secured to the base 14 at the assembly location, but may if appropriate also be delivered separately. Furthermore, the reel holder 22 can be secured to the shield 20 at the assembly location. Then, the palletizing unit 1 can be transported to the location of use. This transport preferably takes place in a container. The dimensions of the unit are selected in such a manner that three units 1 fit into a 40 foot (40 ft.) standard sea container (ISO standardized), as shown in FIG. 8. It is also possible for one unit 1 to be placed in a 20 foot (20 ft.) standard sea container (ISO standardized).

At the user's operating location, it is easy to take the palletizing units 1 out of the container and then place them on the floor 15 within a factory space. The robot 2, the stationing location 11, the introduction conveyor 4 and the safety shields are not taken off the base 14 at the operating location, which contrasts with transport frames which are known from the prior art and to which a robot is secured for transport and then removed again on arrival. The precise position of the abovementioned components with respect to one another on the base 14 is therefore set by the supplier in accordance with the invention.

In a preferred embodiment, casters could also be fitted beneath the frame at the assembly location to make it easy to move the unit. These casters are removed again from the frame during positioning at the location of use.

At the location of use, the conveyor 13 is connected to a conveyor (not shown) for supplying empty pallets 12 and discharging loaded pallets 12 to and from the stationing location 11 of the palletizing cell 1. The introduction conveyor 14 is connected to a supply conveyor (not shown) for loading goods 5 onto the pallets 12.

The palletizing unit 1 is provided with a dedicated control unit (not shown) for controlling at least the robot 2. The conveyor 13 and/or the conveyor 4 are preferably also connected to the control unit and can preferably also be controlled by it. The control unit of the palletizing unit is preferably provided with an electronic connection interface for forming a data link to the connecting devices, in particular supply and/or discharge conveyors for pallets 12 and/or objects 5 that are to be palletized.

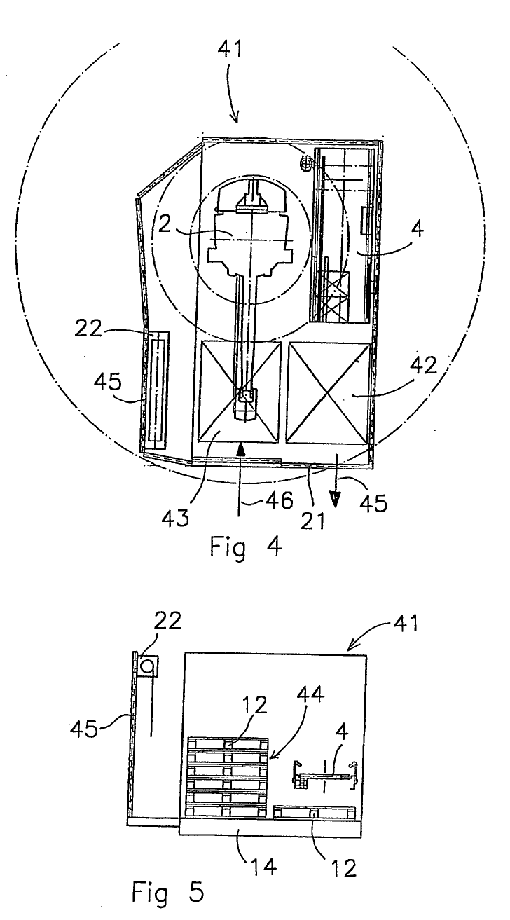

FIG. 4 and FIG. 5 show another embodiment of a palletizing cell according to the invention. In this palletizing cell, which is denoted by reference numeral 41, components which correspond to those of the palletizing cell 1 shown in FIG. 1-3 are denoted by the same reference numerals. In the case of the palletizing unit 41, a stationing location 42 for pallets 12 is arranged directly on the base 14 in line with the introduction conveyor 4. Next to the stationing location 42 for the pallet 12 that is to be palletized there is a stationing location 43 for a stack 44 of empty pallets 12. In this palletizing cell 41, the reel holder 22 is arranged on the other side, on a safety shield 45 disposed outside the base 14. Otherwise, the palletizing cell 41 corresponds to the palletizing cell 1. It should be noted that it would fundamentally also be possible to swap over the stationing location 42 for pallets 12 and the stationing location 43 for the stack 44.

While the palletizing cell 41 is in use, an empty pallet 12 is taken off the stack 44 by the robot 2 and then positioned on the stationing location 42. Then, objects 5 from the introduction conveyor 4 are stacked on the pallet 12 on the stationing location 42 by the robot 2. When the pallet 12 is full, it is conveyed away in the direction indicated by the arrow 45. The stack 44 of pallets 12 is placed in the palletizing cell in the direction indicated by arrow 46. While pallets 12 are being conveyed into and out of the palletizing cell 41, the shield 21 is completely or partially moved away on this side. The head of the robot 2 can if appropriate move the pallet 12 into and out of the palletizing unit 41.

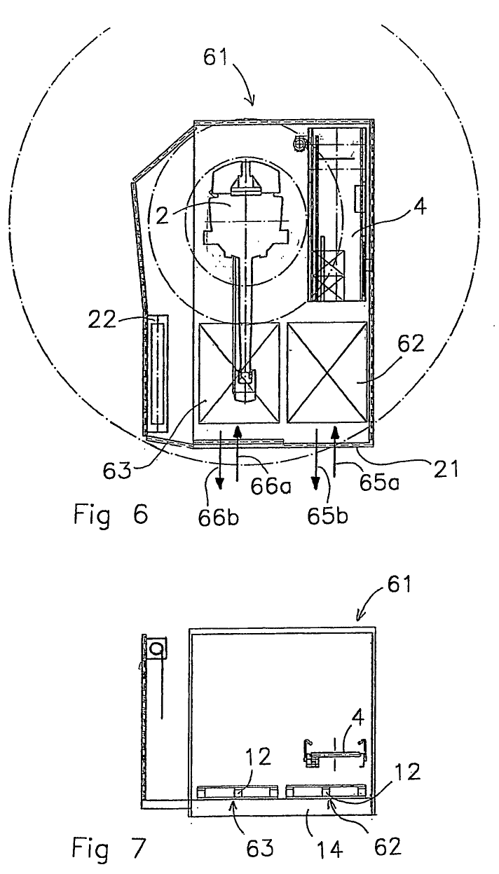

FIG. 6 and FIG. 7 show a palletizing unit 61 with two stationing locations 62 and 63, located next to one another, for pallets 12 to be loaded. The stationing location 62 is located in line with the introduction conveyor 4 and forms a first palletizing position. The stationing location 63 is located directly next to it. In use, the robot 2 can first of all load the objects 5, from the introduction conveyor 4, onto the pallet 12 on one stationing location 62 and can then load the pallet 12 on the other stationing location 63, while in the meantime the loaded pallet on the stationing location 62 can be removed and replaced by an empty pallet 12. It is also possible for two pallets 12 located next to one another to be loaded simultaneously using the robot 2. The pallets are conveyed into and out of the palletizing cell 61 in the direction indicated by the arrows 65a and 66a or 65b and 66b, respectively. In this case too, the shield 21 can be completely or partially moved away at the relevant location in order to allow a pallet 12 to pass through.

The above text has shown three different configurations for a palletizing cell according to the invention. It will be understood that many other configurations which lie within the scope of the invention are also possible.

Furthermore, each of the embodiments shown illustrates a spherical robot. However, it must be understood that other types of robot or manipulator are also within the scope of the invention.

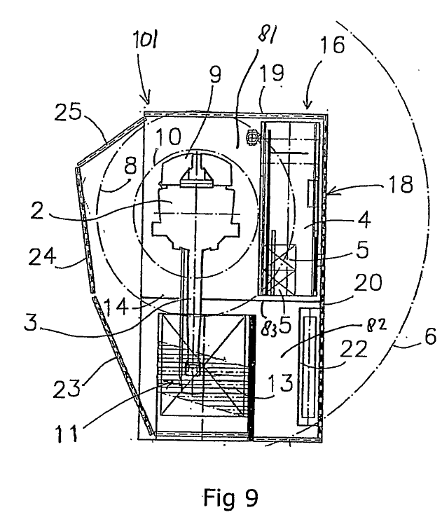

In another preferred embodiment of the invention, the base may comprise a plurality of base modules. In this case, the frame comprises a plurality of frame modules which can be accurately and unambiguously fitted together. An embodiment in which the frame comprises, for example, two frame modules is shown in plan view in FIG. 9. Apart from the base, the design of the palletizing unit 101 is identical to the palletizing unit 1 from FIG. 1. Therefore, corresponding components are denoted by the same reference numerals as in FIG. 1. In this embodiment, the robot 2 and the conveyor 4 are placed on a first frame module 81. The stationing location 11 for pallets is placed on a second frame module 82. The separating line between the frame modules 81 and 82 is denoted by reference numeral 83 in the drawing. These frame modules 81, 82 preferably each have a width of approximately 225 cm. In the assembled form they have a length of preferably approximately 390 cm, like the base frames of the embodiments described above.

The first frame module 81, with the robot 2 and the conveyor 4 on it, and the second frame module 82, with the stationing location 11 on it, can be assembled separately from one another at an assembly location on the supplier's premises. The frame modules 81 and 82 are designed in such a manner that they can be connected to one another unambiguously and in an accurately positioned manner at the location of use, for example using bolted connections. The robot 2, the conveyor 4 and the stationing location 11 are accurately positioned on the respective modules 81 and 82 by the supplier. Since the positioning of the modules 81 and 82 with respect to one another is also accurately defined by the supplier, the robot 2, the conveyor 4 and the stationing location 11 are also accurately set with respect to one another by the supplier.

The safety shields 19-21 can if appropriate also be secured to the base modules 81 and 82 at the assembly location, but can if appropriate also be delivered separately. Furthermore, the reel holder 22 can be secured to the shield 20 at the assembly location.

The palletizing unit 101 can then be transported to the location of use in two parts. This transport preferably takes place in a container. The dimensions of the unit are selected in such a manner that three units 101 fit into a 40 foot (40 ft.) standard sea container (ISO standardized), as shown in FIG. 8. It is also possible for one unit 1 to be placed in a 20 foot (20 ft.) standard sea container (ISO standardized). It is also possible to select the modules 81, 82 so as to form a different filling configuration for the containers.

At the user's operating location, the palletizing units 101 can easily be taken out of the container in two parts, and then the frame modules 81, 82 can be placed against one another on the floor 15 in a factory space. The robot 2, the stationing location 11, the introduction conveyor 4 and the safety shields are not removed from the modules 81 and 82 at the operating location. The frame modules 81 and 82 are connected to one another, for example by means of bolted connections. Then, it is merely necessary to connect the power supply and one or more electronic connection interfaces for forming a data link to the connecting devices in order to make the pelletizing unit 101 ready for operation.

The above text has described a palletizing unit which can be used to load empty pallets. It will be clear that a unit of this type is inherently also suitable for depalletizing loaded pallets, in which case the conveyor is used to discharge depalletized objects from the unit and full pallets in the palletizing cell are placed on the stationing location, and which pallets are discharged again when the objects have been removed from them.

1. A palletizing unit for palletizing and depalletizing objects respectively, comprising at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor, wherein the unit also comprises a base which, after the unit has been installed at an operating location, rests on a floor, on which base the stationing location, the conveyor and the robot are placed and fixedly connected to one another.

2. The palletizing unit according to claim 1, wherein the base comprises a plurality of base modules which can be unambiguously connected to one another.

3. The palletizing unit according to claim 1, wherein the base comprises a frame formed from steel bars or flanged profiled sections.

4. The palletizing unit according to claim 1, wherein the base comprises a plurality of base modules which can be unambiguously connected to one another, each base module comprising a frame module wherein the frame is formed from steel bars or flanged profiled sections.

5. The palletizing unit according to claim 2, wherein the robot and the stationing location and/or the conveyor are arranged on different base modules.

6. The palletizing unit according to claim 1, wherein the stationing location for the pallet can be connected to a pallet conveyor for supplying and discharging pallets.

7. The palletizing unit according to claim 1, wherein the stationing location for the pallet is designed as a conveyor part.

8. The palletizing unit according to claim 1, wherein the unit is provided with at least one safety shield which is connected to the base.

9. The palletizing unit according to claim 1, wherein the unit is provided with a dedicated control unit for controlling at least the robot.

10. The palletizing unit according to claim 9, wherein the control unit of the palletizing unit is provided with an electronic connection interface for forming a data link to the connecting devices, in particular supply and/or discharge conveyors for objects and/or pallets that are to be palletized or depalletized.

11. The palletizing unit according to claim 1, wherein the base or one or more of the base modules, together or separately, have a length and width which are such that they can be placed on the bottom of a 20 foot container.

12. The palletizing unit according to claim 11, wherein the base modules each have a width which approximately corresponds to the width of a 20 foot container.

13. The palletizing unit according to claim 1, wherein the base or the base modules comprise recesses for receiving the fork of a fork-lift truck.

14. A method for installing a palletizing unit, which palletizing unit comprises at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor, wherein at an assembly location the robot, the stationing location and the conveyor are arranged fixedly on a base in order to form a palletizing unit, the unit formed is conveyed to an operating location, where the base of the unit is placed and fixed on a floor surface.

15. The method according to claim 14, wherein the palletizing unit is placed in a container and transported from the assembly location to the operating location.

16. The method according to claim 15, wherein two or three palletizing units are placed in one 40 foot container.

17. The method according to claim 15, wherein one palletizing unit is placed in one 20 foot container.

18. The method according to claim 14, wherein at the operating location the conveyor is connected to a supply or discharge conveyor for objects that are to be palletized or depalletized.

19. The method according to claim 14, wherein at the operating location a pallet conveyor is connected to the palletizing unit for supplying or discharging pallets to or from the stationing location.

20. A method for installing a palletizing unit, which palletizing unit comprises at least one stationing location for a pallet which is to be loaded or has been loaded, a conveyor for introducing and removing objects which are to be palletized and objects which have been depalletized, respectively, into and from the palletizing unit, and a robot for picking up the objects from the conveyor or the pallet and placing the objects onto the pallet on the stationing location or the conveyor, wherein at an assembly location the robot, the stationing location and/or the conveyor are arranged fixedly on one or more base modules, the base modules formed are conveyed to an operating location, where the base modules are placed on a floor surface and are connected to one another in order to form a palletizing unit.
